(19) United States
(12) Patent Application Publication
(10) Pub. No.: US 2009/0325539 A1
(43) Pub. Date: Dec. 31, 2009

(54) Cell Phone Sensor Applications

(76) Inventor: Ajay MALIK, Santa Clara, CA (US)

Correspondence Address: MOTOROLA, INC., 1303 EAST ALGONQUIN ROAD, IL01/3RD, SCHAUMBURG, IL, 60196, US

(21) Appl. No.: 12/145,844

(22) Filed: Jun. 25, 2008

(51) Int. Cl. H04M 11/00

(52) U.S. Cl. 455/405

(57) ABSTRACT

A system includes a sensor receiving unique identity data from a cell phone; and a network component receiving the unique identity data and processing a transaction based on the unique identity data. If the transaction is successfully completed, the network component sends a signal indicating an action to be performed.

### FIELD OF THE INVENTION

The present invention relates generally to a cell phone sensor and related applications. Specifically, an identity of a cell phone is used as a basis for the related applications.

### BACKGROUND

Cellular phones have been developed to include a variety of different functionalities beyond an initial use of making voice communications. Cellular phones have also become universally used. The portability of cellular phones enable the cellular phone to be located on a user's person at all times. Conventionally, a cellular phone includes a transceiver and an antenna to wirelessly transmit and/or receive wireless signals.

### SUMMARY OF THE INVENTION

The present invention relates to a system which includes a sensor receiving unique identity data from a cell phone; and a network component receiving the unique identity data and processing a transaction based on the unique identity data. If the transaction is successfully completed, the network component sends a signal indicating an action to be performed.

### DESCRIPTION OF THE DRAWINGS

FIG. 1 shows a system according to an exemplary embodiment of the present invention.

FIG. 2a shows a first view of a first application of the network system of FIG. 1 according to an exemplary embodiment of the present invention.

FIG. 2b shows a second view of the first application of FIG. 2a.

FIG. 3 shows a view of a second application of the network system of FIG. 1 according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a cell phone sensor and related applications. According to the exemplary embodiments of the present invention, the cell phone sensor (hereinafter “cell sensor”) receives identity data from a cellular phone (hereinafter “cell phone”) to use as a basis for one of the related applications. The cell phone sensor, the cell phone, the identity data, and the related applications will be discussed in further detail below.

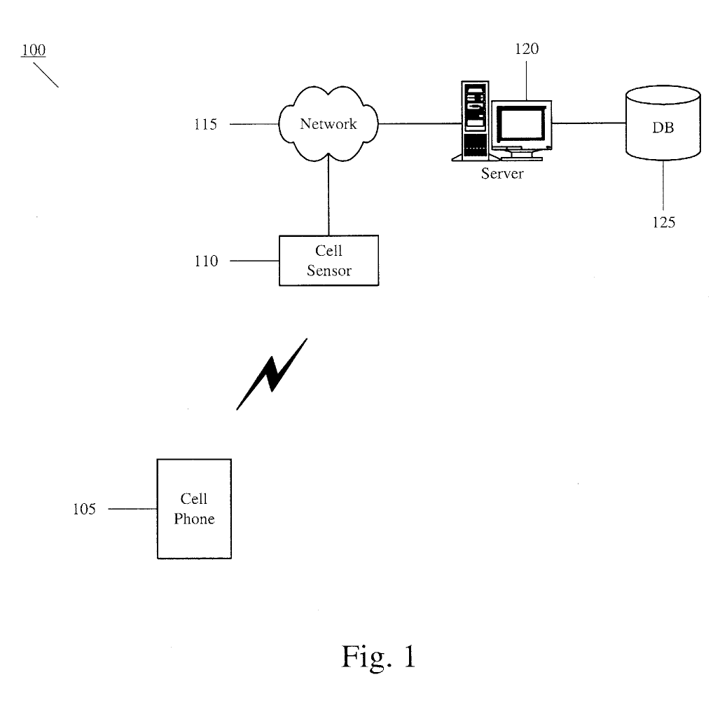

FIG. 1 shows a system 100 according to an exemplary embodiment of the present invention. The system 100 illustrates a general configuration in which exemplary applications of the present invention may be implemented. The exemplary applications will be described in further detail below. The system 100 may include a cell phone 105 and a cell sensor 110 that is part of a network 115.

The cell phone 105 may be any conventional type of cellular phone. Thus, the cell phone 105 may include a transceiver so that wireless signals may be exchanged to and from the cell phone 105 with, for example, a cell tower that provides coverage for the cell phone 105. The cell phone 105 may include other conventional components such as an audio input device (e.g., microphone), an audio output device (e.g., speaker), a keypad (e.g., numeric), a display, a battery, etc.

It should be noted that the use of a cell phone is only exemplary. The exemplary embodiments of the present invention may generally relate to any mobile unit (MU) that is capable of performing an exchange of wireless signals. That is, the cell phone may represent any MU with a transceiver capable of transmitting and/or receiving wireless signals. The MU may be the cell phone or any other portable electronic device such as a mobile computer, a personal digital assistant (PDA), a laptop, a radio frequency identification reader, a scanner, an image capturing device, a pager, etc. The MU may include various components such as a processor, a memory, a battery, a transceiver, an antenna, etc.

The cell phone 105 may be manufactured with conventional protocols. For example, the cell phone 105 may include a unique identifier such as an International Mobile Equipment Identity (IMEI) that identifies the cell phone 105 itself. In another example, the unique identifier may be a model number with an identifying extension. In yet another example, the unique identifier may be an International Mobile Subscriber Identity (IMSI) that identifies the user of the cell phone 105 (e.g., encoded on a SIM card of the cell phone 105). It should be noted that other unique identifying markers may be used and programmed into the cell phone 105 to thereby identify the cell phone 105. For example, the IMEI number may be incorporated into headers of wireless packets to be transmitted. Thus, when a device receives the wireless packet, the header may be decrypted so that the IMEI number may be decoded.

The cell sensor 110 may be a device that is configured to transmit and/or receive a wireless signal to the cell phone 105. Specifically, the cell sensor 110 may be configured for wireless signals of a cellular nature. Because the cell phone 105 operates within a cellular network, wireless signals are of a cellular nature. The cell sensor 110 operating for these types of signals prevents a need for an additional transceiver on the cell phone 105 configured for another type of wireless signal (e.g., WiFi). However, it should be noted that the cell sensor 110 may also be configured for other types of wireless signals.

A first cellular network provider may configure wireless signals of its cellular network to operate at predetermined parameters such as frequency. A further cellular network provider may configure wireless signals of its cellular network to operate at different predetermined parameters. The cell sensor 110 may be configured to accommodate the variety of different parameters in which the cell phone 105 may operate. Thus, according to the exemplary embodiments of the present invention, the cell sensor 110 may operate independent of the operating parameters in which the cell phone 105 is configured. Accordingly, regardless of the cellular network in which the cell phone 105 is associated, the cell sensor 110 may be configured to exchange wireless signals with the cell phone 105. For example, the first network may include a frequency parameter for the wireless signals to operate at 800 MHz. The second network may include a frequency parameter for the wireless signals to operate at 1900 MHz. The cell sensor 110 may be configured to operate at both of these frequencies. Accordingly, if other frequency parameters exist, the cell sensor 110 may further be configured to operate at the other frequency parameters.

As will be described in further detail below, the cell sensor 110 may include features that are substantially similar to those of an access point. The cell sensor 110 includes a transceiver to enable wireless signal exchange with the cell phone 105. The cell sensor 110 may have an operating area. The operating area may determine a distance in which the cell phone 105 is to be disposed for wireless signals to be exchanged therebetween. The operating area of the cell sensor 110 may be configured to encompass predetermined areas. For example, depending upon a power level, the cell sensor 110 may include a substantially spherical operating area radially extending from the cell sensor 110. In another example, the operating area may be shaped according to predefined conditions such as extending from the cell sensor 110 in a conical shape.

In a first exemplary embodiment, the cell sensor 110 may be configured to process the wireless signals exchanged between the cell phone 105 and the cell sensor 110. As discussed above, an identity of the cell phone 105 is used as a basis for the related applications of the exemplary embodiments of the present invention. The cell sensor 110 may be equipped with a processor and a memory so that an appropriate action may be determined as a result of the identity of the cell phone 105. The identity of the cell phone 105 may be referenced to a database of identities stored on the memory and corresponding actions to be taken. The cell sensor 110 may be connected to other components that are to execute the appropriate action.

In a second exemplary embodiment, the cell sensor 110 may be a network component. That is, the cell sensor 110 may forward signals received from the cell phone 105 to be processed by another network component. Specifically, the cell sensor 110 may receive an identity of the cell phone 105 that serves as a basis for a related application according to the exemplary embodiments of the present invention.

As discussed above, the cell sensor 110 may be part of the network 115. The network 115 may be any wireless network such as a local area network (LAN), a virtual local area network (VLAN), a private area network (PAN), a wide area network (WAN), etc. The network 115 may include a server 120 and a database 125.

The server 120 may be configured to be responsible for the operations occurring within the network 115. Specifically, the server 120 may execute the related operation in which the identity of the cell phone 105 has been received. The identity of the cell phone 105 may be referenced to a database of identities and corresponding actions to be taken. The database of identities may be stored in the database 125 which serves as a storage unit of the network 115. The database 125 may store other data relating to the network 115 such as association lists. The network 115 may further include other network components such as switches, network management arrangements, data storage arrangements, etc. For example, the switch may direct other wireless signals from the cell phone 105 (e.g., signals that are not the identity of the cell phone 105) to other network components or other networks with which the network 115 is associated.

When the server 120 has appropriately processed the identity of the cell phone 105, the server 120 may transmit command data so that a corresponding action may be taken, depending on the related application in which the identity of the cell phone 105 is being used. In a first example, the cell sensor 110 may be connected to other components of the related application that is to perform the corresponding action. Thus, the server 120 may transmit the command data back to the cell sensor 110. In a second example, the server 120 may directly transmit the command data to another component responsible for executing the action of the command data.

The cell sensor 110 may receive the identity of the cell phone 105 in a variety of manners. In a first example, the cell sensor 110 may transmit a query beacon. The query beacon may request the identity of the cell phone 105. When the cell phone 105 receives the query beacon, a packet may be transmitted to the cell sensor 110 from the cell phone 105 that includes identity data. In a second example, the cell phone 105 may be configured to continuously broadcast network association packets to remain connected to its respective cellular network. The network association packets may be configured to incorporate identity data in, for example, the headers. The cell sensor 110 may be configured to receive network association packets and decode the header to determine the identity of the cell phone 105. That is, the cell sensor 110 may be in a listening mode. In a third example, the cell phone 105 may be equipped with a locating system (e.g., triangulation, RSSI, GPS, etc.). When the cell phone 105 enters a known location in which a cell sensor 110 is associated, the cell phone 105 may broadcast the identity data. The cell sensor 110 may be in a “hearing” mode to receive the identity data from the cell phone 105.

It should be noted that the system 100 may include additional cell sensors 110. As will be described in further detail below, the cell sensors 110 may be disposed at an entryway for a facility. Thus, if the facility includes multiple entryways, further cell sensors 110 may be disposed for each entryway.

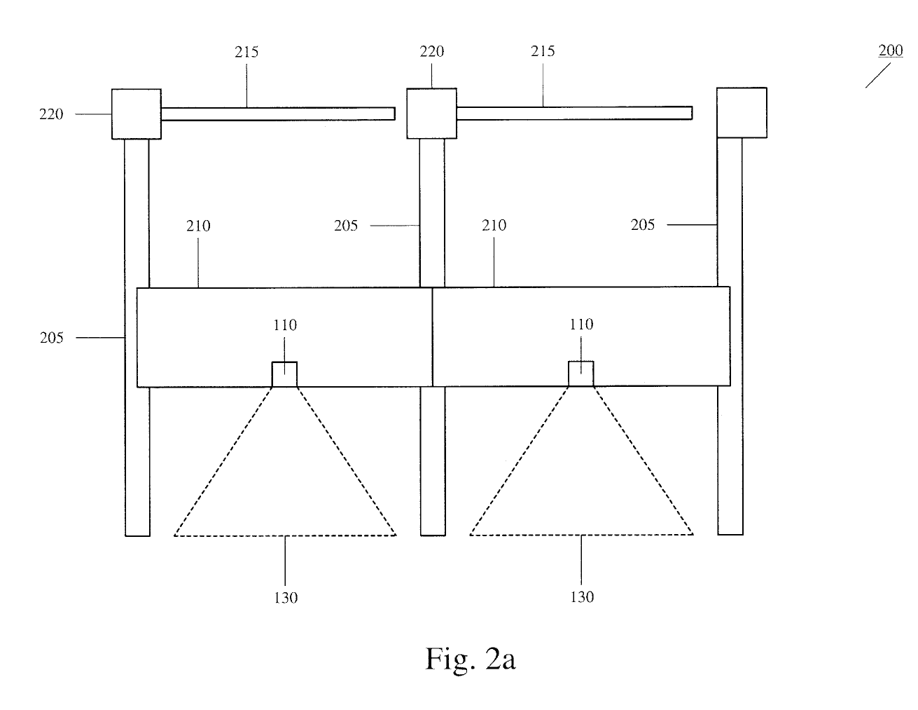

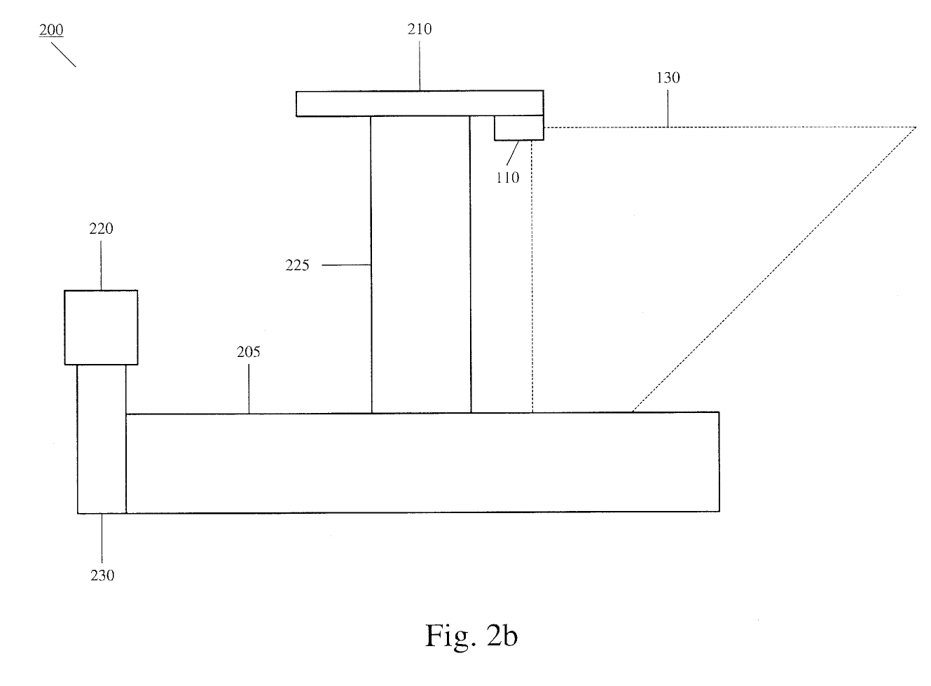

FIG. 2a shows a first view of a first application 200 of the system 100 of FIG. 1 according to an exemplary embodiment of the present invention. The first application 200 relates to a tollbooth for automobiles. The first application 200 may be used to charge an owner of the cell phone 105 a corresponding fare using the identity of the cell phone 105 when the owner passes through a tollbooth while in an automobile. The first view illustrates an overhead view of the first application 200. The first application 200 may include aisle walls 205, overhangs 210, and gates 215 where each has a respective gate controller 220.

The aisle walls 205 create aisles in which an automobile is to approach the gates 215. As illustrated, the first application 200 is a toll booth with two aisles. Accordingly, three aisle walls 205 are included in the configuration. The aisle walls 205 may be disposed at predetermined locations to safely admit any sized automobile. The overhangs 210 are disposed over the respective aisle created by the aisle walls 205. The overhangs 210 may be disposed at predetermined heights to safely admit any sized automobile.

The gates 215 prevent an automobile from exiting the toll booth until the corresponding fare has been processed using the identity of the cell phone 105. Upon the corresponding fare being processed, the gates 215 may be moved by the respective gate controller 220 to enable the automobile to exit the tollbooth. For example, the gate controller 220 may angularly raise the gate 215 from a disposition parallel to the ground to a disposition perpendicular to the ground.

As illustrated in FIG. 2a, the cell sensor 110 may be disposed on the overhang 110. As discussed above, multiple cell sensors 110 may be disposed for the system 100. Because the exemplary embodiment of the first view of the first application 200 includes two aisles, two cell sensors 110 are included where each cell sensor 110 is disposed on one of the overhangs 210. It should be noted that the position of the cell sensor 110 being located on the overhangs 210 is only exemplary. In another exemplary embodiment of the first application 200, the tollbooth configuration may not include the overhangs 210. In such a configuration, the cell sensors 110 may be disposed on the gate controllers 220, the gates 215, the aisle walls 205, etc.

As discussed above, the cell sensor 110 may include an operating area in which an exchange of signals with the cell phone 105 is enabled. As illustrated in the first view of FIG. 2a, the cell sensor 110 may include an operating area 130 that is substantially conical in shape. A third dimension of the operating area 130 will be discussed below with reference to FIG. 2b.

The cell sensor 110 may be configured to receive the identity of the cell phone 105 upon entering the operating area 130. That is, the owner of the cell phone 105 that is activated may be in an automobile that has entered an aisle of the tollbooth. Specifically, the cell phone 105 may have entered the operating area 130 of the cell sensor 110. The cell sensor 110 may receive the identity data from the cell phone 105. According to the exemplary embodiments discussed above, the cell sensor 110 may be configured to process the identity data or the cell sensor 110 may forward the identity data via the network 115 to a network component such as the server 120 to process the identity data to determine an action to be taken by the gate controller 220.

In either embodiment, the identity of the cell phone 105 may be referenced with the database of identities. According to the exemplary embodiment of the first application 200, when the identity of the cell phone 105 is included in the database of identities, a corresponding action may be associated therewith. The corresponding action may be to raise the gate 215 to enable exiting of the vehicle from the aisle of the tollbooth. When the gate 215 is raised, the corresponding fare associated with the identity of the cell phone 105 may be charged. For example, the owner of the cell phone 105 may have an account for the tollbooth system. The account may be a pre-paid or pay-as-you-go account. In another exemplary embodiment, the toll authority may have a relationship with the cell phone carrier and the fare is charged via the cell phone account. Thus, the corresponding fare may be deducted or charged, respectively.

It should be noted that other actions may be taken. For example, the corresponding action may be to deny the gate 215 from being raised to prevent the automobile from exiting the tollbooth. Subsequent actions may also be included such as contacting authorities, capturing an image of the automobile, etc. In another example, if the identity of the cell phone 105 is not included in the database, an image of the license plate of the automobile may be taken so that a citation for a tollbooth violation may be issued.

FIG. 2b shows a second view of the first application 200 of FIG. 2a. The second view includes the components described above such as the aisle walls 205, the overhang 210, the gate controller 220, and the cell sensor 110. Furthermore, the second view illustrates an overhang support 225 and a gate support 230. The overhang support 225 provides an elevation for the overhang 210 to be disposed at the predetermined height while the gate support 230 provides an elevation for the gate controller 220 to be disposed at a predetermined height to sufficiently prevent an automobile from exiting when the gate 215 (not shown) is in a closed position.

The second view further illustrates a disposition of the cell sensor 110 with respect to the overhang 210. Specifically, according to the exemplary embodiment of the first application 200 as illustrated in FIGS. 2a-b, the cell sensor 110 may be disposed underneath the overhang 210 on a side closest to the automobile as it enters the aisle of the tollbooth. The second view further illustrates the operating area 130. As discussed above, the operating area 130 may be a substantially conical shape. The substantially conical shape of the operating area 130 may be configured so that a sufficient area is covered to substantially guarantee that the identity of the cell phone 105 is received by the cell sensor 110.

It should be noted that the first application 200 may include additional components. As discussed above, when the cell phone 105 enters the operating area of the cell sensor 110, the cell sensor 110 may query the cell phone 105 by transmitting a query signal. The query signal may request the identity of the cell phone 105 to be transmitted. To anticipate an automobile entering the operating area of the cell sensor 110, a motion sensor may also be disposed to determine when the automobile has entered the operating area 130 to enable the cell sensor 110 to be aware of when the query signal is to be transmitted.

It is also possible that the cell phone may have a setting to indicate that the account associated with the cell phone should not be charged in certain situations. For example, if there are two people in an automobile with a cell phone, the toll should be charged to only one of the individuals. Thus, the person that is not to be charged may set the cell phone to not respond to queries of sensors 110 or may include a bit (or other indicator) in its beacon signal to indicate that the account associated with this cell phone should not be charged.

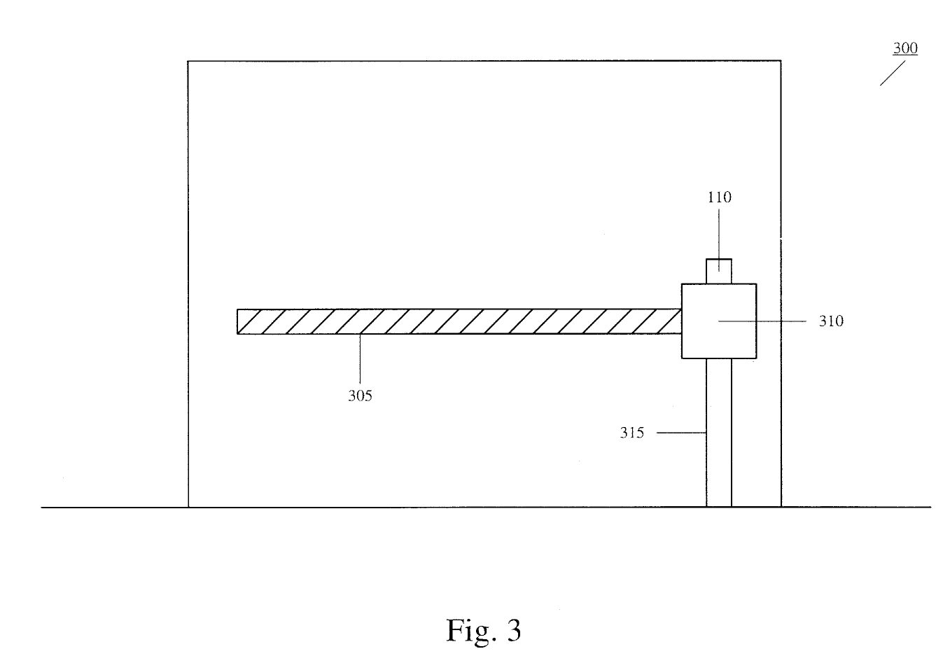

FIG. 3 shows a view of a second application 300 of the system 100 of FIG. 1 according to an exemplary embodiment of the present invention. The second application 300 relates to an access for a parking garage. The second application 300 may be used to charge an owner of the cell phone 105 a corresponding fee using the identity of the cell phone 105 for a duration in which the automobile is kept in the parking garage. The second application 300 may include a gate 305, a gate controller 310, and a gate support 315. The gate 305, the gate controller 310, and the gate support 315 may be substantially similar to the gate 215, the gate controller 220, and the gate support 230, respectively, of FIGS. 2a-b.

As illustrated, the cell sensor 110 is disposed on the gate controller 310. However, it should be noted that the cell sensor 110 may be disposed at other locations such as on a wall of the entryway. The cell sensor 110 may operate in a substantially similar manner as that described above for the cell sensor of the tollbooth of FIGS. 2a-b. Specifically, the cell sensor 110 may include an operating area that is substantially a conical shape, receive identity data of the cell phone 105 as described above, etc.

In the second application 300, in a first exemplary embodiment, the identity data may be used to reference the database. The database may include identities associated with parking permits. Thus, the identity data from the cell phone 105 may indicate that the owner of the cell phone 105 is an authorized person to park an automobile at the parking garage. Thus, the gate 305 may open thereby enabling access. Accordingly, if the database does not include the identity of the cell phone 105, the gate 305 may remain closed thereby denying access.

The following description is for a second exemplary embodiment based upon a parking garage that charges a fee based upon a time in which an automobile is stored in the garage. A first scenario of the second exemplary embodiment may involve maintaining the database with identities of cell phones having permission to park at the parking garage. In this scenario, the identity of the cell phone 105 may be received by the cell sensor 110 to determine a starting time. When exiting the garage, the identity of the cell phone 105 may be received by the cell sensor 110 to determine an ending time. Thus, a total time in which the automobile was left in the parking garage may be determined and a corresponding fee may be determined.

A second scenario of the second exemplary embodiment may involve a dynamic database that is maintained where no identities are pre-stored. That is, the parking garage may be a public lot in which any automobile may park if the corresponding fee is paid. The cell sensor 110 may receive the identity data and create an entry in the database with a corresponding start time when the cell phone 105 (and therefore the automobile) enters the parking garage. The cell sensor 110 may receive the identity data to determine an end time when the cell phone 105 exits the parking garage. Subsequently, a confirmation of payment may be performed in a variety of manners. For example, the cellular network may be identified via the identity data. The network provider may be informed of the additional fee for parking and the owner of the cell phone 105 may be accordingly charged on the cell phone bill. In another example, the cell phone 105 may be configured to receive signals from the cell sensor 110 that are interpreted to open a confirmation screen on a display of the cell phone 105. The confirmation screen may indicate the fee for parking and an appropriate measure may be taken to pay the amount (e.g., entering of credit card information, requesting the cellular network provider to forward a bill, etc.).

It should be noted that further applications exist for the exemplary system 100 of the present invention. For example, in a facility such as a warehouse, access to certain locations may be restricted, presence in a location is monitored, etc. The exemplary embodiments of the present invention enable the identity of the cell phone to provide access to the location, serve as a location determining value, etc. That is, the cell sensor 110 may be used for these further applications in a substantially similar manner as the applications discussed above (e.g., receiving identity data and performing a corresponding task).

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A system, comprising:
a sensor receiving unique identity data from a cell phone; and
a network component receiving the unique identity data and processing a transaction based on the unique identity data, wherein, if the transaction is successfully completed, the network component sends a signal indicating an action to be performed.

2. The system of claim 1, wherein the unique identity data is one of an International Mobile Equipment Identity (IMEI) and an International Mobile Subscriber Identity (IMSI).

3. The system of claim 1, wherein the transaction is for a payment at a toll booth.

4. The system of claim 3, wherein the action is a raising of a toll gate.

5. The system of claim 3, wherein the payment is charged to one of an account of the toll booth and an account of the cell phone.

6. The system of claim 1, wherein the transaction is for a payment at a parking location.

7. The system of claim 6, wherein the action is a raising of a parking gate.

8. The system of claim 6, wherein the payment is charged to one of an account of the parking location and an account of the cell phone.

9. The system of claim 1, wherein the network device receives the unique identity data as a function of one of a query beacon, a listening mode, and a locating system.

10. The system of claim 1, wherein the sensor is configured with operating parameters with which the cell phone operates.

11. A method, comprising:
receiving unique identity data from a cell phone;
processing a transaction based on the unique identity data;
indicating a first action to be performed if the transaction is completed; and
indicating a second action to be performed if the transaction is unsuccessful.

12. The method of claim 11, wherein the unique identity data is one of an IMEI and an IMSI.

13. The method of claim 11, wherein the transaction is for a payment at a toll booth.

14. The method of claim 13, wherein the first action is a raising of a toll gate.

15. The method of claim 13, further comprising:
charging the payment to one of an account of the toll booth and an account of the cell phone.

16. The method of claim 11, wherein the transaction is for a payment at a parking location.

17. The method of claim 16, wherein the first action is a raising of a parking gate.

18. The method of claim 16, further comprising:
charging the payment to one of an account of the parking location and an account of the cell phone.

19. The method of claim 11, further comprising:
one of transmitting a query beacon, listening for a transmission from the cell phone, and determining a location of the cell phone prior to receiving the unique identification data.

20. A system, comprising:
a sensing means for receiving unique identity data from a cell phone; and
a network component receiving the unique identity data and processing a transaction based on the unique identity data, wherein, if the transaction is successfully completed, the network component sends a signal indicating an action to be performed.
